(19) United States
(12) Patent Application Publication
(10) Pub. No.: US 2015/0149567 A1
(43) Pub. Date: May 28, 2015

(54) SMART NOTIFICATIONS

(71) Applicant: Viper Media S.a.r.l., Luxembourg (LU)

(72) Inventors: Michael Shmilov, Rishon LeZion (IL); Ido Iungelson, Rishon LeZion (IL); Chen Abarbanel, Tel Aviv (IL)

(73) Assignee: Viper Media S.a.r.l., Luxembourg (LU)

(21) Appl. No.: 14/397,226

(22) PCT Filed: Jun. 13, 2013
(86) PCT No.: PCT/IB2013/054848

§ 371 Date: Oct. 27, 2014

Related U.S. Application Data
(60) Provisional application No. 61/672,921, filed on Jul. 18, 2012.

(51) Int. Cl. H04L 12/58; G06F 17/30

(52) U.S. Cl. CPC H04L 51/043; G06F 17/30091
USPC 709/206

(57) ABSTRACT

A system and method for delivering messages to participants in an instant messaging session, the participants running an IM application, comprising: receiving by a server a message from a first participant's IM application, addressed to at least one other participant; for each the at least one other participants: if the participant is active in the session—sending the message by the server to the participant; and if the participant is inactive in the session—sending a silent notification by the server to the participant.

### CROSS-REFERENCE TO RELATED PATENT APPLICATIONS

This patent application claims priority from and is related to U.S. Provisional Patent Application Ser. No. 61/672,921, filed Jul. 18, 2012, this U.S. Provisional Patent Application incorporated by reference in its entirety herein.

### FIELD OF THE INVENTION

The present invention pertains to the field of Instant Messaging and more particularly to notifications sent to users participating in an IM session.

### BACKGROUND

Instant messaging (IM) is a form of real-time direct text-based chatting communication in push mode between two or more people using personal computers or other devices, along with shared clients. The user's text is conveyed over a network, such as the Internet. More advanced instant messaging software clients also allow enhanced modes of communication, such as live voice or video calling and inclusion of links to media.

Most IM programs provide these features:
Instant messages—Send notes back and forth with a friend who is online
Chat—Create a chat room with friends or co-workers
Web links—Share links to your favorite Web sites
Video—Send and view videos, and chat face to face with friends
Images—Look at an image stored on your friend's computer
Sounds—Play sounds for your friends
Files—Share files by sending them directly to your friends
Talk—Use the Internet instead of a phone to actually talk with friends
Streaming content—Real-time or near-real-time stock quotes and news
Mobile capabilities—Send instant messages from your cell phone

The steps involved in originating an IM session are signaling and media channel setup, encoding, packetizing, and transmission as e.g. Internet Protocol (IP) packets over a packet-switched network. On the receiving side, similar steps (usually in the reverse order) such as reception of the IP packets, decoding of the packets and digital-to-analog conversion reproduce the original text or voice stream.

IM is available on many smartphones and Internet devices and enables users to place calls or send text messages over communication channels such as 3G or Wi-Fi.

When a message is sent to a user participating in an IM session or group chat, the user receives from the system server a notification alerting him of the pending message.

In group conversations or “chats”, the number of participants may be three or more, which means that many notifications are likely to be sent to each participant.

It may be beneficial to control the number of notifications receive by IM session participants, so as to render the use of IM more user friendly.

### SUMMARY

According to a first aspect of the present invention there is provided a method of delivering messages to participants in an instant messaging session, said participants running an IM application, comprising: receiving by a server a message from a first participant's IM application, addressed to at least one other participant; for each other participants: determining whether said other participant is active in the session; if said participant is determined to be active—sending the message by the server to said participant; and if said participant is determined to be inactive—sending a silent notification by the server to said participant.

The method may additionally comprise, for each inactive participant—storing said message in said server storage.

The method may additionally comprise providing a visual cue in said inactive participant's IM application GUI.

The visual cue may comprise a counter.

The method may additionally comprise sending by the server said stored message to said participant when said participant becomes active.

The method may additionally comprise, for each inactive participant—sending the message by the server to said inactive participant and storing the message in the inactive participant's storage device.

The method may additionally comprise increasing a displayed counter in said inactive participant's IM application GUI.

Determining whether said other participant is active in the session may comprise detecting an increase in the percentage of active participants in the session.

Determining whether said other participant is active in the session may comprise identifying said other participant as responsive to the first participant.

Determining whether said other participant is active in the session may comprise detecting a drastic increase in conversation tempo relative to an ongoing calculated average.

Determining whether said other participant is active in the session may comprise identifying location change of said other participant.

Determining whether said other participant is active in the session may comprise identifying stopped driving for a predefined length of time.

According to a second aspect of the present invention there is provided a system for delivering messages to participants in an instant messaging session, comprising: a system server; a plurality of user communication devices running an IM application, said communication devices configured to communicate over a network with other users' communication devices, said system server configured to: receive a message from a first participant's IM application, addressed to at least one other participant; for each said at least one other participants: determine whether the participant is active in the session; if said participant is active in the session—send the message to said participant; and if said participant is inactive in the session—sending a silent notification to said participant.

The system may additionally comprise, for each inactive participant—storing said message in said server.

The system may additionally comprise increasing a displayed counter in said inactive participant's IM application GUI.

The system may additionally comprise sending by the server said stored message to said participant when said participant becomes active.

The system may additionally comprise, for each inactive participant—sending the message by the server to said inactive participant and storing the message in the inactive participant's storage device.

The system may additionally comprise increasing a displayed counter in said inactive participant's IM application GUI.

The system may be configured to determine whether said other participant is active in the session by detecting an increase in the percentage of active participants in the session.

The system may be configured to determine whether said other participant is active in the session by identifying said other participant as responsive to the first participant.

The system may be configured to determine whether said other participant is active in the session by detecting a drastic increase in conversation tempo relative to an ongoing calculated average.

The system may be configured to determine whether said other participant is active in the session by identifying location change of said other participant.

The system may be configured to determine whether said other participant is active in the session by identifying stopped driving for a predefined length of time.

### BRIEF DESCRIPTION OF THE DRAWINGS

For a better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 is a schematic drawing of the system component for carrying out the present invention;

FIG. 2 is a schematic drawing showing the data transmission routes according to the present invention;

FIG. 3 shows an exemplary UI for indicating aggregated messages for various applications; and

FIG. 4 is a flowchart showing the process performed by the system according to the present invention.

### DETAILED DESCRIPTION OF PREFERRED EMBODIMENTS

The present invention provides a system and method for overcoming the disadvantages of existing Instant Messaging (IM) systems, by aggregating notifications to users participating in an IM session or group chat, according to predefined criteria.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

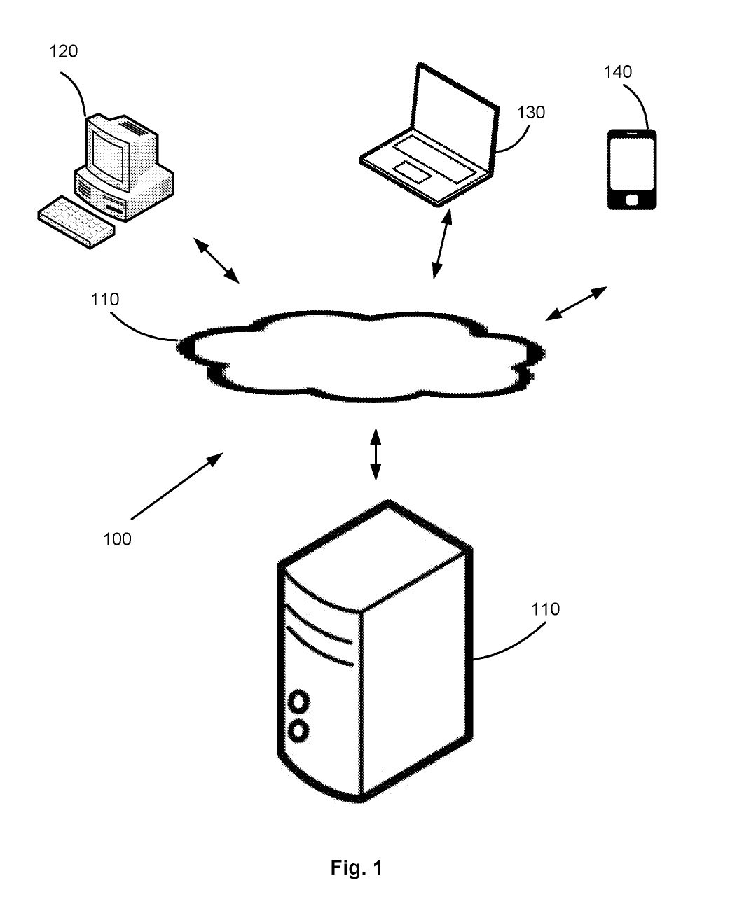

FIG. 1 is a schematic drawing showing the system component for carrying out the present invention. The system 100 comprises a plurality of users participating in an IM session using exemplary communication devices: a computer 120, a laptop 130 and a smartphone 140.

The communication devices (120, 130, 140) communicate bidirectionally with the IM service server 110 over a communications network (e.g. Internet), using an IM application such as Viber (www.viber.com),

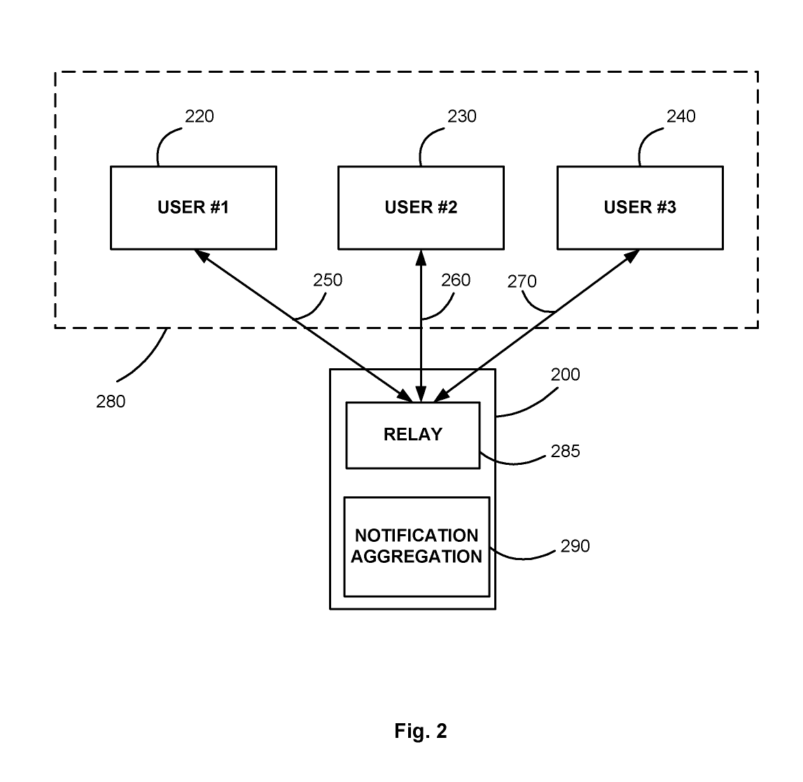

FIG. 2 is a schematic drawing showing the data transmission routes according to the present invention.

In the example of FIG. 2, three users (220, 230, 240) are currently participating in an IM group conversation (or group chat) 280.

A system server 200, comprises a software relay 285, which may be implemented, for example, as a table mapping account-IDs to devices and connections to those devices (e.g. via TCP), or as a push-service by sending a message to all the IM applications running on the devices connected to the account ID using, for example, Google's C2DM service or Apple Push Service.

The relay 285 receives messages entered by each of the participants and communicates them to the other active participants (250, 260, 270). An active participant may be defined in the system according to various criteria such as, for example, the user has read messages for that conversation or sent messages for that conversation or viewed the conversation screen in the last 15 minutes.

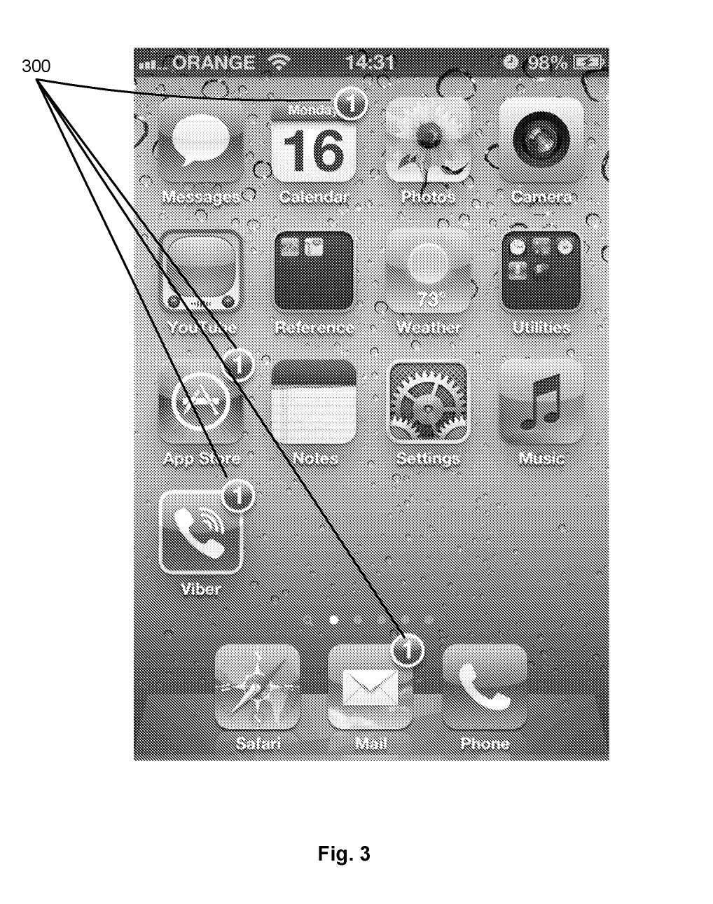

On the other hand, a user may be inactive, in which case the system may refrain from automatically sending him incoming messages or sounding an audible cue alerting him of a pending message, but rather aggregate the messages for the inactive user in the system server and send him a “silent” notification notifying him that he has unread messages (e.g. 300, FIG. 3). Alternatively, a notification may be sent to the inactive user (only when the first message is received after a user became inactive), such as: “You have new messages in Poker Buddies” or “You have new messages in your conversation with George Kosta”. According to yet another embodiment, instead of aggregating messages in the system server, the messages may be sent to the inactive user, but with a flag marking them as “silent”, whereby they will be aggregated in the user application and may provide an unobtrusive user interface indication such as updating a badge.

The messages for each inactive participant may be aggregated in a notification aggregation storage 260 on the server 200, or passed to the device which will add them to its local message database.

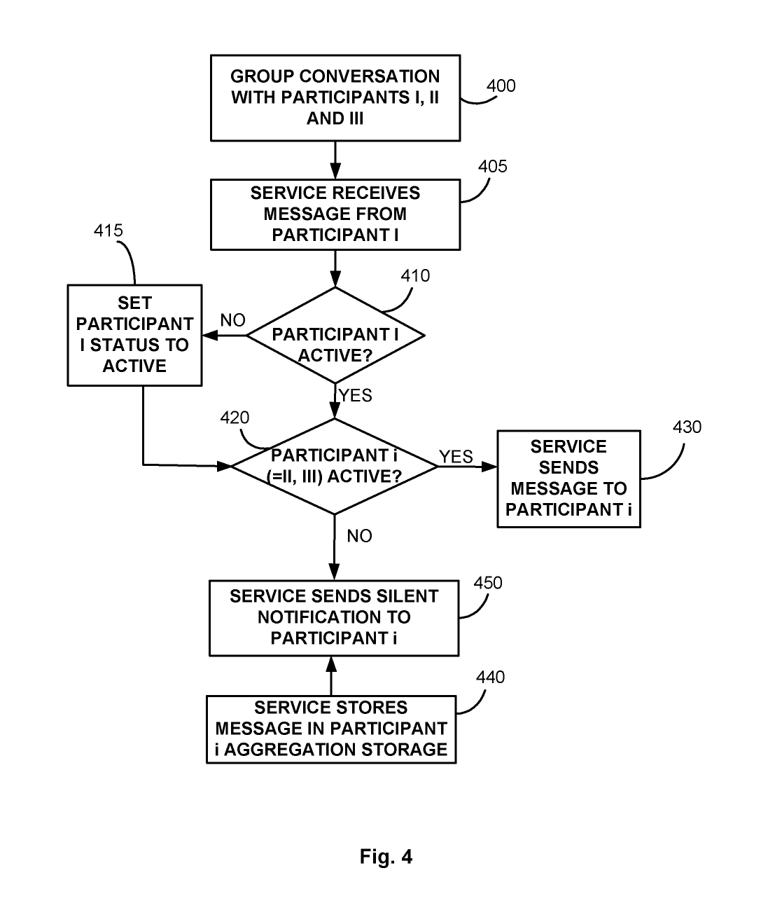

FIG. 4 is a flowchart showing the process performed by the system according to the present invention.

In step 400, a group conversation is taking place with three participants (I, II and III).

In step 405 the system receives a message from participant I, to be communicated to the other participants.

In step 410 the system checks whether the sending participant I is defined as active. If not—participant l's status is changed to active (step 415).

The system then goes over the list of participants in the conversation and checks, for each one of them, whether it is active (step 420) according to predefined criteria such as described above. If the participant is determined to be active, the system communicates the message to the participant (step 430).

If in step 420 the participant was determined to be inactive, the system may store the message in the participant's aggregation storage (step 440) (which means it must be sent to the user when the device is active again) and the system sends the inactive participant a silent notification (step 450), as described above.

According to embodiments of the present invention, If in step 420 the participant was determined to be inactive, the system may send the message including a “silent” flag to the inactive participant.

According to yet another embodiment, the service may not maintain any status for the participants—instead, all messages are sent. The user application then performs the logic locally (same logic that works at the server):
First, it has to maintain a state—let's call it “Silence” mode per conversation
When receiving a new message:
   If the silence mode is active, the message is stored in local message store; a badge count may be increased
   If silence mode is inactive:
      Check if we need to change to silence mode (e.g. 15 minutes since user has entered the conversation screen)
      If we need to change to silence mode:
         Show “You received . . . message to user
         Set silence mode—and go to silence mode handling (above)
      Otherwise, just show message normally
When user reads message in a conversation:
   Reset silence mode
   Mark time (e.g. start counting the 15 minutes again)

Both server and client handling can be used at the same time (server is required when the app is not running on the device, for example).

In case of server handling, the device must notify the server that the conversation was entered—to reset the silence state, and to read any pending messages for this conversation currently waiting on the server.

According to embodiments of the invention, resetting silence mode, i.e. defining a device as active and sending it a notification regarding aggregated messages, may be triggered by a plurality of events; for example:
Increase in the percentage of active participants from the group—all silent participants will receive notifications;
One of the inactive participants is identified by the system as always responsive to the sender—the responsive participant will receive notification;
Drastic increase in conversation tempo relative to an ongoing calculated average—all silent participants will receive notifications;
Identifying location change, e.g. participant steps out of a meeting using for example Wi-Fi-based positioning system (WPS) for indoors positioning or GPS if the meeting was conducted outside—silent participant will receive notification,
Identifying stopped driving for a predefined length of time using e.g. GPS—silent participant will receive notification.

1. A method of delivering messages to participants in an instant messaging session, said participants running an IM application, comprising:
receiving by a server a message from a first participant's IM application, addressed to at least one other participant;
for each other participants:
determining whether said other participant is active in the session;
if said participant is determined to be active—sending the message by the server to said participant; and
if said participant is determined to be inactive—sending a silent notification by the server to said participant.

2. The method of claim 1, additionally comprising, for each inactive participant—storing said message in said server storage.

3. The method of claim 2, additionally comprising providing a visual cue in said inactive participant's IM application GUI.

4. The method of claim 3, wherein said visual cue comprises a counter.

5. The method of claim 2, additionally comprising sending by the server said stored message to said participant when said participant becomes active.

6. The method of claim 1, additionally comprising, for each inactive participant—sending the message by the server to said inactive participant and storing the message in the inactive participant's storage device.

7. The method of claim 6, additionally comprising increasing a displayed counter in said inactive participant's IM application GUI.

8. The method of claim 1, wherein said determining whether said other participant is active in the session comprises detecting an increase in the percentage of active participants in the session.

9. The method of claim 1, wherein said determining whether said other participant is active in the session comprises identifying said other participant as responsive to the first participant.

10. The method of claim 1, wherein said determining whether said other participant is active in the session comprises detecting a drastic increase in conversation tempo relative to an ongoing calculated average.

11. The method of claim 1, wherein said determining whether said other participant is active in the session comprises identifying location change of said other participant.

12. The method of claim 1, wherein said determining whether said other participant is active in the session comprises identifying stopped driving for a predefined length of time.

13. A system for delivering messages to participants in an instant messaging session, comprising:
a system server;
a plurality of user communication devices running an IM application, said communication devices configured to communicate over a network with other users' communication devices,
said system server configured to:
receive a message from a first participant's IM application, addressed to at least one other participant;
for each said at least one other participants:
determine whether the participant is active in the session;
if said participant is active in the session—send the message to said participant; and
if said participant is inactive in the session—sending a silent notification to said participant.

14. The system of claim 13, additionally comprising, for each inactive participant—storing said message in said server.

15. The system of claim 14, additionally comprising increasing a displayed counter in said inactive participant's IM application GUI.

16. The system of claim 14, additionally comprising sending by the server said stored message to said participant when said participant becomes active.

17. The system of claim 13, additionally comprising, for each inactive participant—sending the message by the server to said inactive participant and storing the message in the inactive participant's storage device.

18. The system of claim 17, additionally comprising increasing a displayed counter in said inactive participant's IM application GUI.

19. The system of claim 13, configured to determine whether said other participant is active in the session by detecting an increase in the percentage of active participants in the session.

20. The system of claim 13, configured to determine whether said other participant is active in the session by identifying said other participant as responsive to the first participant.

21. The system of claim 13, configured to determine whether said other participant is active in the session by detecting a drastic increase in conversation tempo relative to an ongoing calculated average.

22. The system of claim 13, configured to determine whether said other participant is active in the session by identifying location change of said other participant.

23. The system of claim 13, configured to determine whether said other participant is active in the session by identifying stopped driving for a predefined length of time.
